(19) United States
(12) Patent Application Publication
(10) Pub. No.: US 2006/0105091 A1
(43) Pub. Date: May 18, 2006

(54) Non-toxic lava fluids for use in children's products

(75) Inventor: Wing Sum Vincent Kwan, Chicago, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: SANFORD L.P., Freeport, IL (US)

(21) Appl. No.: 10/988,148

(22) Filed: Nov. 12, 2004

(51) Int. Cl. A23D 9/00

(52) U.S. Cl. 426/601

(57) ABSTRACT

A non-toxic, edible novelty fluid composition is disclosed which includes a polar system comprising at least one polar solvent selected from the group consisting of glycerol, one or more glycols, aqueous NaCl, KCl or other non-toxic salt solutions, and mixtures thereof, a non-polar system comprising at least one edible oil, and at least one dye soluble in either the polar or the non-polar system. The polar system and non-polar system are immiscible with respect with each other and provide a lava-type novelty fluid for decorative purposes. Because the fluid is non-toxic, may be safely incorporated into children's products, examples of which include writing instruments, pencil sharpeners and rulers.

### TECHNICAL FIELD

Non-toxic, edible novelty fluids of the “lava” type are shown and described and incorporated into articles that are safe for use by children. The disclosed novelty fluids include at least one heavy polar phase including a polar solvent selected from the group consisting of glycerol, one or more glycols, salt water such as NaCl, KCl, or other edible salt solutions, and mixtures thereof and with or without added water as a co-solvent. The fluids also include at least one light, non-polar phase that comprises at least one edible oil. At least one dye that is either soluble in polar system or soluble in non-polar system is also included. Both phases may be colored or dyed as well. The disclosed fluids may be contained within reservoirs incorporated into drawing tools such as rulers and protractors, writing instruments, pencil sharpeners, calculators and other objects used by children.

### BACKGROUND OF THE RELATED ART

Since the introduction of the popular “lava lamp” in the 1960's, so-called “lava fluids”, which are a combination of two immiscible fluids with different specific gravities, have been used in creating novelty toys and decorations. Typically, a lava system includes at least two immiscible fluids of different specific gravities and different colors. At rest, the heavier fluid will settle to the bottom of the reservoir while the lighter fluid will form an upper layer. As the container is moved or rotated, the heavier fluid will flow down through the lighter fluid due to gravitational pull. The relative movements of the fluids generated by this flow creates fascinating and interesting visual effects for adults and children.

The original lava lamps did not need to be turned or rotated as relative movement of the immiscible liquids with respect to each other was created by heat generated by an electric bulb in the base of the lamp. More specifically, globules of contrasting colored fluids of different specific gravities would flow gently upward and downward under the influence of internal convection currents and gravity. The operation of the original lava lamp is explained in detail in U.S. Pat. No. 3,387,396.

The original lava lamp fluid formulation included water, solidified globules of mineral oil, paraffin wax or petroleum jelly and light hydrocarbons such as light paraffins, carbon tetrachloride and additional dyes. The light or low density phase included components that are essentially toxic and not fit for human consumption. As a result, it was important to house the lava lamps in sturdy, durable housing that could not be easily cracked or broken to thereby limit the possibility of the lava materials coming into contact with small children.

Currently available in novelty products that include lava-type systems still rely upon the use of toxic materials for the low density phase. One common material used is “isopar,” which is a family of synthetically produced isoparaffinic fluids having a specific gravity ranging from 0.84-0.86. Isopar provides a suitable low density phase of a two component system and the heavy phase can be either water-bases or another solvent having a specific gravity of 1 or greater than 1. However, isopar is not safe for human consumption or even prolonged skin contact.

The visual effects of two immiscible fluids of a lava-type system remains fascinating and attention-getting. Lava-type fluid systems remain useful as a decorative accent.

One area in which lava-type fluid systems are not applicable are in children's products and the decoration of children's products. The reason is simple: currently available lave-type fluid systems include toxic materials which cannot be safely exposed to children. Thus, to incorporate a lava-type fluid system in a children's product, the reservoir or container would need to be extremely robust. This physical requirement eliminates the possibility of using such a lava-type fluid system in many inexpensive children's products.

Thus, there is a need for a safe lava-type fluid system that can be used with children's products and which, if the reservoir or container is broken, would not harm a child if skin contact is made or if some of the fluid components are accidentally ingested.

### SUMMARY OF THE DISCLOSURE

An improved non-toxic, edible novelty fluid composition is disclosed which comprises: a polar system comprising at least one polar solvent selected from the group consisting of glycerol, one or more glycols, aqueous KCl, NaCl or other edible salt solutions, and mixtures thereof; a non-polar system comprising one edible oil; and at least one dye soluble in either the non-polar system or the polar system. The polar system is the heavy phase of the essentially two-phase system and the non-polar system is the light phase. Of course, both the polar and non-polar systems may be dyed. Further, more than two immiscible fluids (i.e., three or more phases) may be used.

In a refinement, the edible oil is selected from the group consisting of coconut oil, palm oil, peanut oil, sesame seed oil, rice bran oil, soybean oil, cottonseed oil, olive oil, canola oil, corn oil, sunflower seed oil, safflower oil, infused oil, almond oil, apricot kernel oil, jojoba oil, grape seed oil, rape seed oil, cod liver oil, salmon oil, tuna oil, citrus oil, castor oil, mineral oil and mixtures thereof.

In another refinement, the composition further comprises a viscosity modifier. In such a refinement, the viscosity modifier may be selected from the group consisting of Sufynol™, Dynol™, Envirogem™, one or more lecithins and mixtures thereof. Generally 'speaking, additives in the form of alkyn-diols, polyalkyneoxides, alkylphenolethoxylates, alkylphenylsulfates, alkylesters and mixtures thereof may be used.

In another refinement, the at least one dye soluble in the polar system is selected from the group consisting of FD&C Blue 1, FD&C Green 3, FD&C Yellow 5, FD&C Yellow 6, FD&C Black 2, FD&C Red 40, and mixtures thereof. These dyes are edible and non-toxic.

In yet another refinement, the at least one dye soluble in the non-polar system is selected from the group consisting of Solvent Red 164, Solvent Blue 70, Oil Black 2, Solvent Blue 90, solvent yellow and mixtures thereof.

In another refinement, ingestible particles such as glitter particles are included in the composition.

In still another refinement, the composition also comprises a polar co-solvent. Preferably, the co-solvent is water. In yet another refinement of the concept, the water is a NaCl or KCl solution to increase the density thereof. Such a NaCl or KCl solution could replace glycerol or glycol as the heavy polar phase.

The above non-toxic, edible novelty fluid composition may be incorporated in a number of different children's products as the composition is non-toxic, edible and non-irritating. One such product would be a writing instrument which would include an enclosed reservoir, either somewhere in the middle or at an end of the writing instrument with the above-described novelty fluid composition contained within the reservoir. Preferably, the reservoir includes a clear housing and one or more baffles or restrictors to impede, yet permit fluid flow from one end of the reservoir to the other.

In another refinement, the above-described novelty fluid composition is contained within a reservoir disposed on or within a ruler, protractor or straight edge. Preferably, reservoir is elongated and disposed between the parallel straight edges. Still more preferably, the reservoir includes one or more baffles restrictor elements disposed along the reservoir to impede the flow and create more interesting flow patterns for the child when the reservoir is tilted.

In a different refinement, a reservoir holding the above-described novelty fluid is part of a pencil sharpener. In an embodiment, the clear reservoir holding the novelty fluid is annular and an inner housing is accommodated within the annular outer reservoir. The inner housing accommodates a blade holder and a compartment for holding shavings. Again, reservoir should include some sort of baffles or restrictors to make the flow patterns more interesting.

The disclosed novelty fluid compositions may also be used with calculators, various drawing tools other than those specifically discussed herein and various other types of writing and marking instruments.

### BRIEF DESCRIPTION OF THE DRAWING

The incorporation of the above non-toxic, edible novelty fluid compositions into products suitable for children is described more or less diagrammatically in the accompanying drawings, wherein:

FIG. 1 is a sectional view of a writing instrument incorporating a separate reservoir in the form of an end plug or end cap that can house one of the novelty fluid compositions disclosed herein;

FIG. 2 is an exploded view of the writing instrument shown in FIG. 1;

FIG. 3 is a top plan view of another writing instrument incorporating a reservoir for housing a disclosed novelty fluid composition;

FIG. 4 is a sectional view taken substantially along line 4-4 of FIG. 3;

FIG. 5 is a partial sectional view illustrating the reservoir and restrictor of the writing instrument shown in FIG. 3;

FIG. 6 is a sectional view of a pencil sharpener with an outer annular reservoir suitable for containing one of the novelty fluid compositions disclosed herein;

FIG. 7 is an exploded view of the pencil sharpener shown in FIG. 6;

FIG. 8 is a front plan view of an alternative embodiment to the pencil sharpener disclosed in FIG. 6;

FIG. 9 is a sectional view of the alternative pencil sharpener shown in FIG. 8;

FIG. 10 is a front plan view of a ruler which includes a central elongated reservoir for containing one of the novelty fluid compositions disclosed herein;

FIG. 11 is an end view of the ruler shown in FIG. 10;

FIG. 12 is a sectional view taken substantially along line 12-12 of FIG. 10;

FIG. 13 is another front plan view of the ruler shown in FIG. 10 with additional detail and illustrating multiple phases of the novelty fluid disposed within the central elongated reservoir;

FIG. 14 is a front plan view of a calculator incorporating a reservoir disposed beneath the keypad that can accommodate a disclosed novelty fluid composition;

FIG. 15 is a sectional view taken substantially along line 15-15 of FIG. 14;

FIG. 16 is a top plan view of a protractor incorporating a elongated reservoir for accommodating a disclosed novelty fluid composition; and

FIG. 17 is a sectional view taken substantially along line 17-17 of FIG. 16.

In certain instances, details which are not necessary for an understanding of the disclosed writing instruments, pencil sharpeners, rulers, or protractors may have been omitted. It will be also noted that the disclosed novelty fluids may be safely incorporated into other products suitable for children in addition to pencil sharpeners, writing instruments, rulers and protractors. This disclosure is therefore not limited to the concept of incorporating the disclosed novelty fluid compositions into the specific devices shown here, but, instead, is applicable to any and all products intended for use by children.

### DETAILED DESCRIPTION OF THE PRESENTLY PREFERRED EMBODIMENTS

Improved non-toxic, edible novelty fluid compositions are disclosed which provide a “lava-type” effect and which are safe for use in products for children because of their non-toxic, edible nature. Essentially, the disclosed novelty fluid compositions comprise two edible fluids. The two fluids include a heavy phase and a light phase.

The heavy phase, which also happens to be a polar phase comprises an edible polar solvent selected from the group consisting of glycerol, one or more glycols and mixtures thereof. Glycerol and/or glycols are used for the heavy, polar phase because of their high specific gravity and high polarity. Glycerol has a specific gravity at room temperature of about 1.26, ethylene glycol has a specific gravity at room temperature of about 1.11 and propolene glycol has a specific gravity at room temperature of 1.03. Both glycols and glycerol are polar and therefore miscible with each other and with water. Further, because of their polarity, all three of these polar solvents can be used with water as a co-solvent. Further, glycerol and glycols are safe, even for ingestion. Other useful fluids for the heavy phase include NaCl solutions or KCl solutions due to their high polarity, non-toxicity and relatively high specific gravities. MgCl₂ and MgSO₄ solutions will also work. the salt(s) should be added to the water in an amount sufficient to increase the specific gravity of the resulting solution to greater than 1.0 to increase the density of the polar phase.

The second fluid or phase is an edible oil. Oils are generally non-polar and using an edible, food-source oil, in combination with non-toxic polar solvents results in a harmless novelty fluid composition. The edible oils may be selected from the following group but additional edible oils could be utilized: coconut oil, palm oil, peanut oil, sesame seed oil, rice bran oil, soybean oil, cottonseed oil, olive oil, canola oil, corn oil, sunflower seed oil, safflower oil, infused oil, almond oil, apricot kernel oil, jojoba oil, grape seed oil, rape seed oil, cod liver oil, salmon oil, tuna oil, lemon oil, other citrus oils, castor oil, edible mineral oils (USP grade) and mixtures thereof.

Most edible oils have specific gravities of less than 0.95 which is in contrast to specific gravities of glycerol and glycol, both exceeding 1.0. Thus, the two phases, the heavy polar phase and the edible non-polar light oil phase, both have sufficiently different specific gravities so as to create interesting relative flow patterns relative to one another. In general, the greater differences between the specific gravities of the heavy and the light phase, the more interesting the relative flow patterns are.

Glycerol is an excellent polar solvent because of its high specific gravity. Even with using water as a co-solvent, glycerol can provide a heavy phase polar mixture that still possesses a specific gravity of over 1.1. However, because of their high specific gravities, glycols and glycol-containing fluids that are safe for ingestion are also particularly useful.

In certain situations, an inner surface of the container or reservoir may be hydrophilic. Further, spacing between opposing walls of the container or reservoir may be extremely narrow. Either of these two situations would cause insufficient fluid flow to provide the desired optical effects. To circumvent this slow fluid flow, additives like viscosity modifiers or surface tensions reducers can be utilized. Such additives need to be safe for ingestion at the concentrations utilized. Examples of such additives include, but are not limited to surfactants like Sufynol Dynol™, Envirogem™, and one or more lecithins. More generally, alkyn-diols, polyalkyneoxides, alkylphenolethoxylates, alkylphenylsulfates, alkylesters and mixtures thereof may be used. Such additives can be used to change viscosity and surface tension. However, the additives should be used in concentrations that are low enough so that the polar heavy phase will not become miscible in the lighter oil phase. In most situations, when needed, an effective concentration of the additives is less than 5% by weight and more preferably less than 1% by weight of the total formulation.

As mentioned above, the oil should be edible, have a low viscosity and a low density are properties that are important in facilitating the movement to the polar-heavy phase. Preferably, the oil should have the specific gravity of less than 1 and more preferably less than about 0.95. While the oil should also be of a low viscosity, a definition of this parameter without the container or reservoir geometry or dimensions is not meaningful.

To insure that the phases are visually distinctive, colorants may be added to each phase. Of course, more than two immiscible phases are possible.

Only one of the two phases needs to be colored leaving the other phase colorless or clear; however, coloring both phases may provide more interesting products. In the polar, heavy phase food colorants that are approved by FDA are most preferable. Examples of such dyes include, but are not limited to, FD&C Blue 1, FD&C Green 3, FD&C Yellow 5, FD&C Yellow 6, FD&C Black 2, FD&C Red 40, mixtures thereof and the like. Combinations of at least two of these listed dyes are also possible to produce the entire spectrum. To maintain good transparency, it is important to minimize the loading of the dye. To that end, the concentration of the dye should not exceed 1% by weight of the fluid, and more preferably the total concentration of the dye(s) should be less than 0.1 % by weight of the formulation.

Since the availability of FDA approved oil-soluble dyes is limited, it is even more critical to lower the concentration of the dyes so that the oil mixture remains safe to be ingested. Desirable concentration of the dyes will be less than 1% by weight, and more preferably less than 0.1 % by weight of the formulation. Applicable oil-soluble dyes include, but are not limited to Solvent Red 164, Solvent Blue 70, Oil Black 2, Solvent Blue 90, solvent yellow mixtures thereof and the like. Some of these dyes are supplied as a solution in oil mixture already and consequently, the effective concentration of the dye is even less than 1 wt %.

Examples 1 and 2 below depict the compositions of the heavy, polar phases. In essence, the various components were weighed and mixed together in a container for about 30 minutes.

TABLE 1
Components for the Heavy Phase and their uses.

Example

| | Function | 1 | 2 |
|---|---|---|---|
| Glycerol 96% | Glycerol | 0.8333 | 0.8333 |
| Water | Co-solvent | 0.1653 | 0.1617 |
| FD&C Red 40 | Colorant | 0.0014 | |
| FD&C Black 2 | Colorant | | 0.005 |
| Total Fraction | | 1 | 1 |

Examples 3-5 depict the compositions of the light non-polar phase or the oil phase. In essence, the various components were weighed and mixed together for 30 minutes.

TABLE 2
Components for the Light Phase and their uses.

| | Example | | |
|---|---|---|---|
| | 3 | 4 | 5 |
| Light Phase | Blue | Green | Magenta |
| soy bean oil (Bleached) | 0.99996 | 0.9995764 | 0.9999465 |
| Spectra Liquid Blue | 0.00004 | 0.0000229 | |
| 8HF (Spectra Color) | | | |
| Spectra Yellow GR HF | | 0.0004006 | |
| Liquid (Spectra Color) | | | |
| Unisol Liq. Red 6BHF | | | 0.0000534 |
| Total Fraction | 1 | 0.999 | 0.999 |

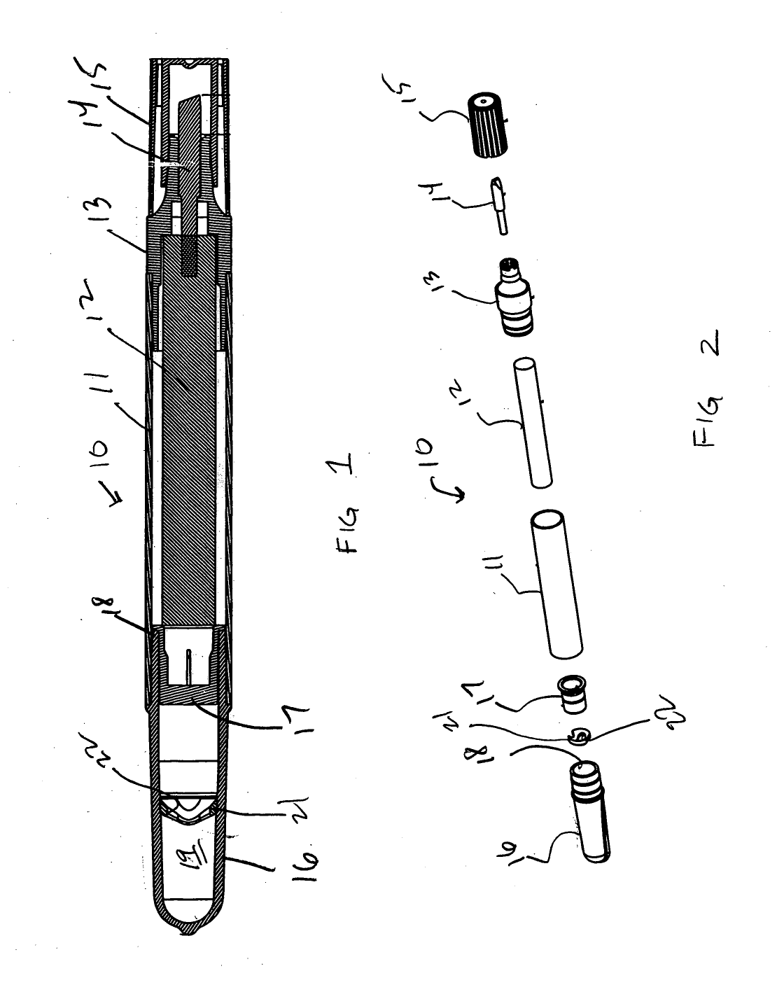

When 1.2 cc of Example 1 and 2.4 cc of Example 3 were added to an end plug reservoir with a partition in the middle as shown in FIGS. 1 and 2 below, fluid in Example 1 flowed into Example 3 to create an interesting and appealing “drop-by-drop” flow pattern.

Thus, mixture of two or more immiscible, edible fluids with very different specific gravities was described. The fluid combination is safe to ingest and creates attention getting flow patterns when introduced into specifically designed space.

Further, small amounts of ingestible glitter particles may be added to the fluid mixture. Also, additional ingestible fluids like milk, juices, soft drink mixtures and solutions having plant or animal origins may be added to the heavy polar phase. Finally, certain safe and edible salts such as NaCl and KCl may be added to increase the density of the heavy polar phase when water is used as a co-solvent.

Turning to FIGS. 1 and 2, an improved writing instrument 10, which can be used by children, is shown and described. The pen 10 includes a barrel 11 that accommodates an ink reservoir 12. An end of the ink reservoir 12 is also partially accommodated in the ferrule 13 which establishes fluid communication between the reservoir 12 and the tip or nib 14. The ferrule 13 is then mateably received in an end cap 15. A distal end of the barrel 11 mateably receives a lava reservoir an end plug 17.

As best seen in FIG. 1, the open proximal end 18 of the reservoir 16 receives the plug 17 to provide the sealed space shown at 19. A mixture of heavy polar and light non-polar phases are contained within the reservoir 16. As described above, larger quantities of the lighter non-polar phase and smaller quantities of the heavy polar phase is preferred. To enhance the interaction between the light and heavy phases, a restrictor element 21 is utilized. As seen in FIG. 2, a restrictor element 21 includes a non-circular aperture 22 for enhancing the turbulence of flow through the restrictor 21 and generating a “drop-by-drop” flow pattern through the restrictor 21.

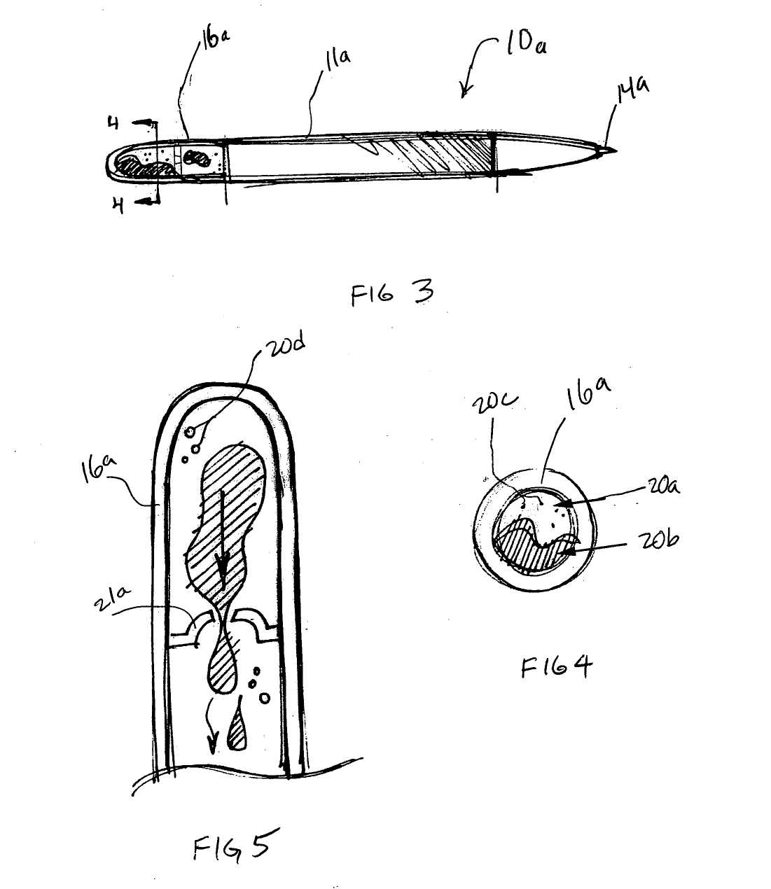

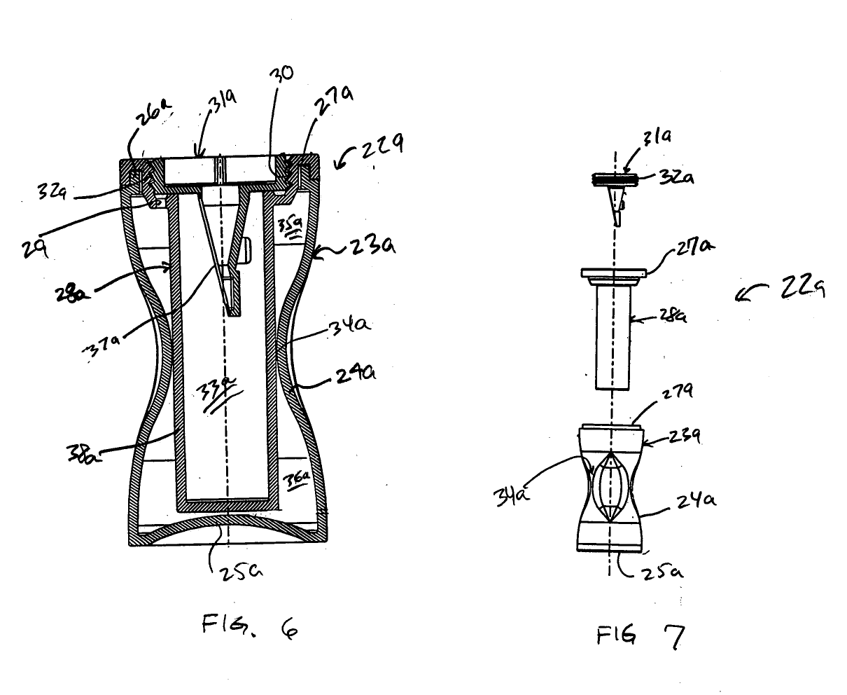

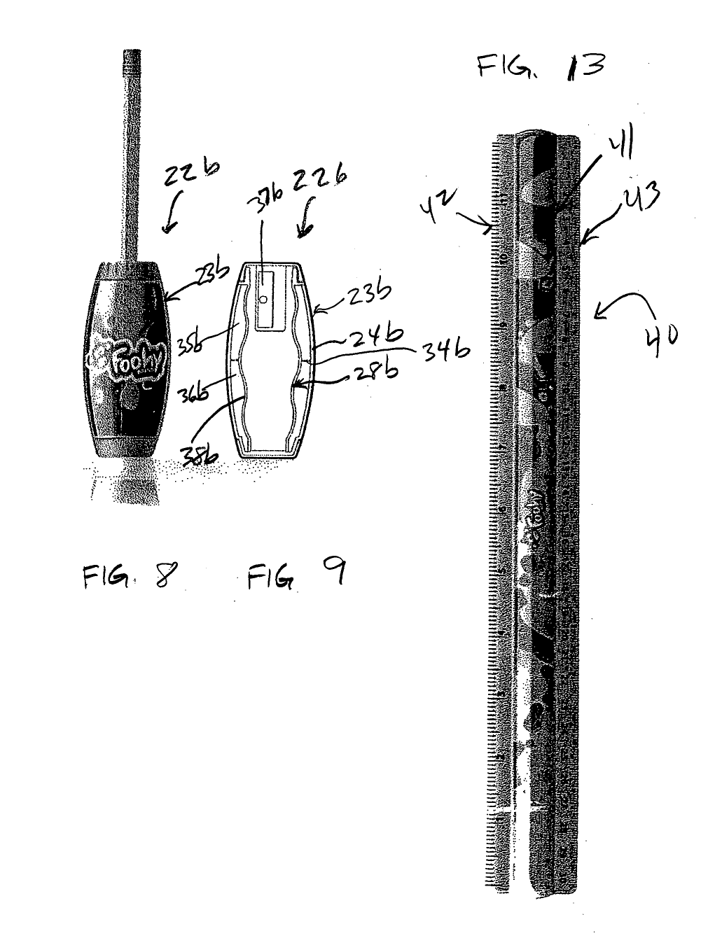

Turning to FIGS. 3-5, an alternative embodiment 10a to the writing instrument 10 shown in FIGS. 1 and 2 is illustrated. The writing instrument 10a includes a separate liquid reservoir 16a that houses a disclosed novelty fluid composition. The reservoir 16a is in the form of an end cap attached to an end of the barrel 11a. As shown in FIG. 4, the particular fluid composition shown includes two phases 20a, 20b that also includes a plurality of sparkle or glitter particles 20c. As shown in FIG. 5, bubbles 20d may be intentionally included. Turning to FIG. 5, an alternative restrictor or baffle element 21a is shown.

Turning to FIGS. 6-9, two pencil sharpeners 22a, 22b are shown and described. As shown in FIG. 6 a pencil sharpener 22a includes an outer housing 23a having an outer wall 24a and an end or bottom wall 25a. An upper rim 26a is mateably received within an upper rim 27a of an inner housing 28a. The upper rim 26a of the outer housing 23a may be connected to the upper rim 27a of the inner housing 28a by glue or welding or other suitable attachment scheme that will not prevent the leakage of lava fluid. The inner housing 28a includes a fill hole 29 for the injection of lava fluid therethrough. The hole 29 is then plugged or sealed (not shown).

The upper rim 27a of the inner housing 28a includes a threaded inner wall 30 which threadably receives a blade holder 31a. The blade holder 31a also includes a complimentary outer threaded wall 32a for threadably connecting the blade holder 31a to the inner wall 30 of the inner housing 28a. The blade holder 31a carries the blade 37a and the interior space 33a of the inner housing 28a serves as a reservoir or space for accommodating shavings, etc.

For the pencil sharpener 22a shown in FIGS. 6 and 7, it will be noted that the annular space shown at 34a between the middle portion of the outer housing 23a and the inner housing 28a is sufficiently narrow so that the two walls provide a baffle or a restrictor. Thus, it is evident from FIG. 6 that the shape of the outer housing 23a relative to the inner housing 28a provides a sufficient restrictor or baffle element for interesting flow patterns between the upper annular space 35a and lower annular space 36a.

Turning to FIGS. 8 and 9, another embodiment of a pencil sharpener 22b is shown. In contrast to the hour glass-shaped outer housing 23a as shown in FIG. 6, the sharpener 22b of FIGS. 8 and 9 include an outer housing 23b that has a convex outer wall 24b. In contrast to the cylindrical inner housing 28a as shown in FIG. 6. The inner housing 28b features an undulating outer wall 38b which helps to provide interesting flow patterns for the lava-type fluid disposed in the upper and lower annular spaces 35b, 36b respectively. In addition, an annular baffle or restrictor is shown at 34b.

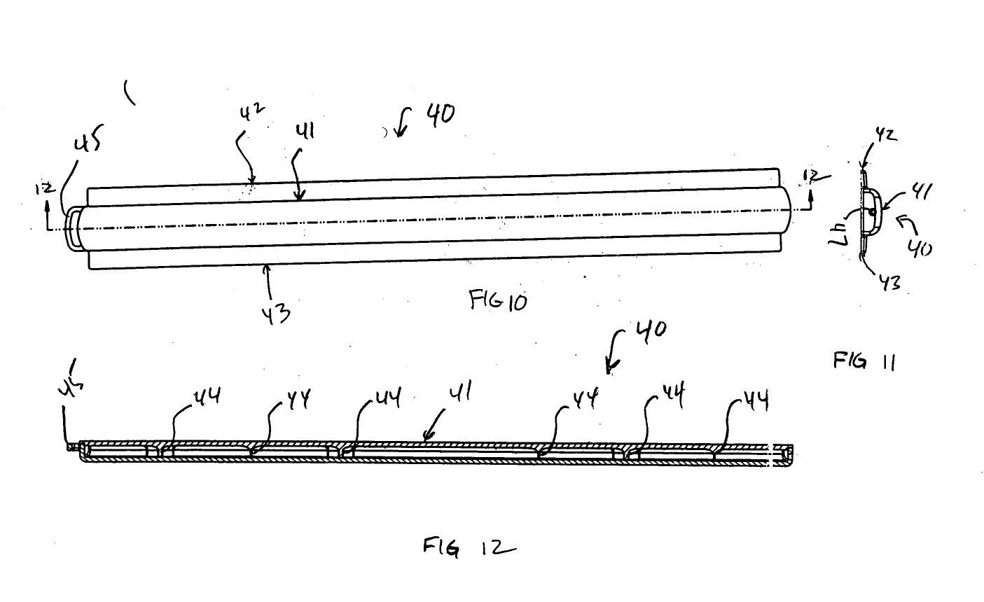

Turning now to FIGS. 10-13 a ruler 40 is shown which includes a central elongated reservoir 41 disposed between two outer straight edges 43, 44. Of course, the straight edges 43, 44 may include indicia for indicating measurements as shown in FIG. 13. As shown in FIG. 10, the reservoir includes a plurality of restricting elements or baffles all of which are shown at 44 for creating interesting flow patterns for the heavy and light phases of the lava-type novelty fluid. A loop 45 may be utilized for hanging the ruler from a peg or other mounting device (not shown). A fill hole 47 is used to inject the fluid before it is plugged (not shown). Conventional polymer plugs and friction fit bearings may be used to seal the hole 47.

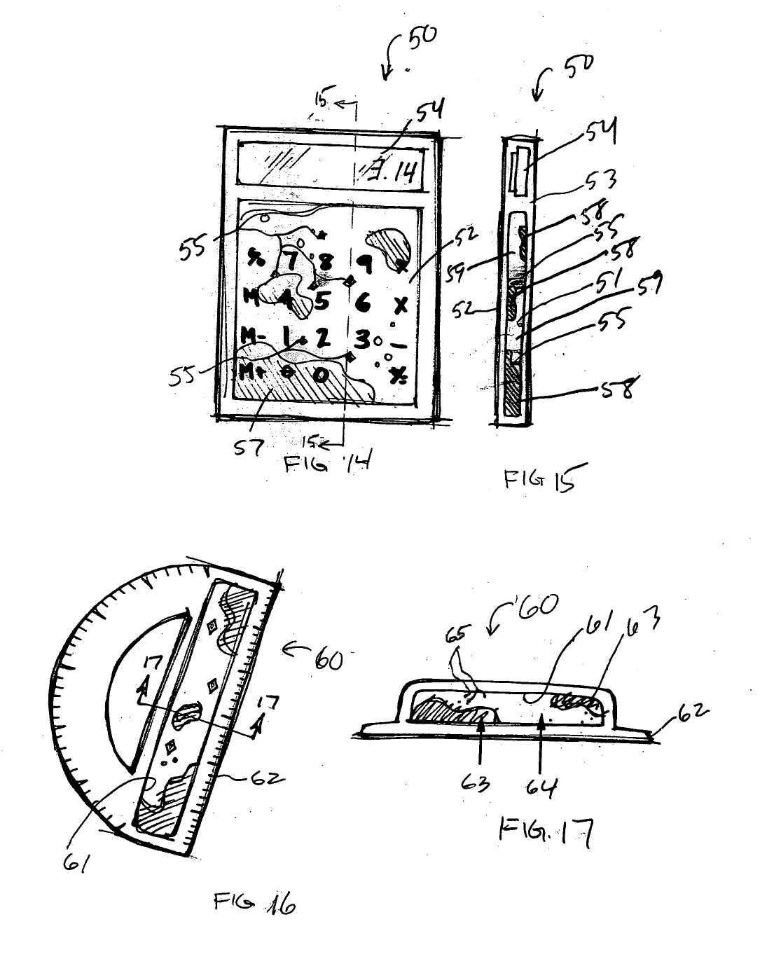

Turning to FIGS. 14 and 15, a calculator 50 which includes a reservoir 51 disposed beneath the keypad 52 is illustrated. The calculator 50 includes a rigid housing 53 and a display 54. Also, the reservoir space shown at 51 includes one or more bumpers or baffles shown generally at 55 which are incorporated to breakup the lava composition flow and provide interesting flow patterns. As with the other embodiments, glitter or sparkle particles may be added to the lava fluid composition. In the embodiment shown in FIGS. 14 and 15, two immiscible fluids 58, 59 are shown.

Turning to FIGS. 16 and 17, a protractor 60 which includes a reservoir 61 that extends parallel to the straight edge 62 is illustrated. In this embodiment, the reservoir 61 holds a two-phase liquid with the phases being indicated generally at 63 and 64. In addition, glitter particles shown at 65 are included in the lava fluid composition.

It will be apparent to those skilled in the art that a reservoir containing a disclosed lava fluid composition could be added to other children's products. Therefore, this disclosure is not limited to the particular embodiments illustrated in FIGS. 1-17.

Therefore, a mixture of two immiscible, edible fluids with different specific gravities and different polarities that therefore render the fluids immiscible in each other is shown and described. The edible two-phase, non-toxic, novelty fluid composition disclosed herein is safe for use in children's products. No component of the lava-type fluids shown and described is toxic or poisonous. Further, while the reservoirs 16, 23a, 23b, 41, 51 and 61 of the writing instruments, pencil sharpeners, rulers, calculators and protractors shown and described here should be fabricated from robust materials for long lasting qualities and extended use. If a curious child were to rupture one of the reservoirs and the lava-type fluid were to leak out, the fluid would not be harmful, even if the curious child were to taste it or rub it on his/her skin. In short, the disclosed non-toxic edible, novelty fluid compositions are both interesting to a child and harmless.

Accordingly, a multiphase immiscible fluid system that is non-toxic and edible and products which can use the disclosed system as a decorative and attention-getting element. While writing instruments, pencil sharpeners and rulers utilizing the disclosed novelty fluid system as a decorative element are shown and described, other products suitable for children may include the disclosed fluids. Thus, this disclosure is not limited to the use of a disclosed novelty fluid compositions with writing instruments, pencil sharpeners and rulers, but instead, this disclosure applies to other products which may be used by children and adults. The specific details set forth above are simply by way of examples and are not intended to limit this disclosure or the appended claims.

What is claimed:

1. A non-toxic, edible novelty fluid composition, the composition comprising:
a polar system comprising at least one polar solvent selected from the group consisting of an aqueous NaCl solution, an aqueous KCl solution, an aqueous MgCl₂ solution, an aqueous MgSO₄ solution, glycerol, one or more glycols, and combinations thereof,
a non-polar system comprising at least one edible oil,
at least one dye soluble in either the polar or the non-polar system.

2. The composition of claim 1 wherein the edible oil is selected from the group consisting of coconut oil, palm oil, peanut oil, sesame seed oil, rice bran oil, soybean oil, cottonseed oil, olive oil, canola oil, corn oil, sunflower seed oil, safflower oil, infused oil, almond oil, apricot kernel oil, jojoba oil, grape seed oil, rape seed oil, cod liver oil, salmon oil, tuna oil, citrus oil, castor oil, mineral oil and mixtures thereof.

3. The composition of claim 1 further comprising a viscosity modifier.

4. The composition of claim 3 wherein the viscosity modifier is selected from the group consisting of alkyn-diols, polyalkyneoxides, alkylphenolethoxylates, alkylphenylsulfates, alkylesters, one or more lecithins and mixtures thereof.

5. The composition of claim 1 wherein the at least one dye is soluble in the polar system is selected from the group consisting of FD&C Blue 1, FD&C Green 3, FD&C Yellow 5, FD&C Yellow 6, FD&C Black 2, FD&C Red 40, and mixtures thereof.

6. The composition of claim 1 wherein the at least one dye is soluble in the non-polar system is selected from the group consisting of Solvent Red 164, Solvent Blue 70, Oil Black 2, Solvent Blue 90, solvent yellow and mixtures thereof.

7. The composition of claim 1 wherein the polar system comprises at least one of glycerol or a glycol and water as a co-solvent.

8. The composition of claim 1 further comprising ingestible glitter particles.

9. A writing instrument comprising a reservoir comprising a clear housing and containing the composition of claim 1.

10. The writing instrument of claim 9 wherein the reservoir includes at least one restrictor for impeding flow of the composition within the reservoir.

11. A ruler instrument comprising a reservoir comprising a clear housing and containing the composition of claim 1.

12. The ruler of claim 1 1 wherein the reservoir includes at least one restrictor for impeding flow of the composition within the reservoir.

13. A pencil sharpener instrument comprising a reservoir comprising a clear housing and containing the composition of claim 1.

14. The pencil sharpener of claim 13 wherein the reservoir includes at least one restrictor for impeding flow of the composition within the reservoir.

15. A writing instrument comprising:
a sealed reservoir comprising a clear housing and a sealing element, the clear housing accommodating at least one restricting element to restrict flow of liquid within the reservoir,
the reservoir accommodating a non-toxic novelty fluid composition, the composition comprising
a polar system comprising at least one polar solvent selected from the group consisting of glycerol, one or more glycols, an aqueous NaCl solution, an aqueous KCl solution, an aqueous MgCl₂ solution, an aqueous MgSO₄ solution, and mixtures thereof,
a non-polar system comprising at least one edible oil, and
at least one dye soluble in either the polar or the non-polar system, and
the reservoir and sealing element being connected to a barrel.

16. The writing instrument of claim 15 wherein the edible oil of the liquid is selected from the group consisting of coconut oil, palm oil, peanut oil, sesame seed oil, rice bran oil, soybean oil, cottonseed oil, olive oil, canola oil, corn oil, sunflower seed oil, safflower oil, infused oil, almond oil, apricot kernel oil, jojoba oil, grape seed oil, rape seed oil, cod liver oil, salmon oil, tuna oil, citrus oil, castor oil, mineral oil and mixtures thereof.

17. The writing instrument of claim 15 wherein the liquid further comprises a viscosity modifier.

18. The writing instrument of claim 17 wherein the viscosity modifier is selected from the group consisting of alkyn-diols, polyalkyneoxides, alkylphenolethoxylates, alkylphenylsulfates, alkylesters one or more lecithins and mixtures thereof.

19. The writing instrument of claim 15 wherein the at least one dye is soluble in the polar system is selected from the group consisting of FD&C Blue 1, FD&C Green 3, FD&C Yellow 5, FD&C Yellow 6, FD&C Black 2, FD&C Red 40, and mixtures thereof.

20. The writing instrument of claim 15 wherein the at least one dye is soluble in the non-polar system is selected from the group consisting of Solvent Red 164, Solvent Blue 70, Oil Black 2, Solvent Blue 90, solvent yellow and mixtures thereof.

21. A drawing tool comprising:
an elongated member comprising two parallel straight edges with an elongated reservoir disposed therebetween,
the reservoir comprising a clear housing portion and at least one baffle element to impede flow of liquid within the reservoir, the reservoir housing a non-toxic novelty fluid composition, the composition comprising
a polar system comprising at least one polar solvent selected from the group consisting of glycerol, one or more glycols, an aqueous NaCl solution, an aqueous KCl solution, an aqueous MgCl₂ solution, an aqueous MgSO₄ solution, and mixtures thereof,
a non-polar system comprising at least one edible oil, and
at least one dye soluble in either the polar or the non-polar system.

22. The drawing tool of claim 21 wherein the edible oil of the liquid is selected from the group consisting of coconut oil, palm oil, peanut oil, sesame seed oil, rice bran oil, soybean oil, cottonseed oil, olive oil, canola oil, corn oil, sunflower seed oil, safflower oil, infused oil, almond oil, apricot kernel oil, jojoba oil, grape seed oil, rape seed oil, cod liver oil, salmon oil, tuna oil, citrus oil, castor oil, mineral oil and mixtures thereof.

23. The drawing tool of claim 22 wherein the liquid further comprises a viscosity modifier.

24. The drawing tool of claim 22 wherein the viscosity modifier is selected from the group consisting of alkyn-diols, polyalkyneoxides, alkylphenolethoxylates, alkylphenylsulfates, alkylesters one or more lecithins and mixtures thereof.

25. The drawing tool of claim 22 wherein the at least one dye is soluble in the polar system is selected from the group consisting of FD&C Blue 1, FD&C Green 3, FD&C Yellow 5, FD&C Yellow 6, FD&C Black 2, FD&C Red 40, and mixtures thereof.

26. The drawing tool of claim 22 wherein the at least one dye is soluble in the non-polar system is selected from the group consisting of Solvent Red 164, Solvent Blue 70, Oil Black 2, Solvent Blue 90, solvent yellow and mixtures thereof.

27. The drawing tool of claim 22 further comprising ingestible glitter particles.

28. A pencil and crayon sharpener comprising:
an inner housing comprising an open end that accommodates a blade holder and an closed end with a shavings reservoir disposed therebetween,
an outer housing comprising an open end which mateably and sealably receives the inner housing and a closed end with an annular reservoir space disposed therebetween, the annular reservoir space including in least one baffling element to restrict flow of liquid within the annular reservoir space, the annular reservoir space accommodating a non-toxic novelty fluid composition, the composition comprising
a polar system comprising at least one polar solvent selected from the group consisting of glycerol, one or more glycols an aqueous NaCl solution, an aqueous KCl solution, an aqueous MgCl₂ solution, an aqueous MgSO₄ solution and mixtures thereof,
a non-polar system comprising at least one edible oil, and
at least one dye soluble in either the polar or the non-polar system.

29. The pencil and crayon sharpener of claim 28 wherein the edible oil of the liquid is selected from the group consisting of coconut oil, palm oil, peanut oil, sesame seed oil, rice bran oil, soybean oil, cottonseed oil, olive oil, canola oil, corn oil, sunflower seed oil, safflower oil, infused oil, almond oil, apricot kernel oil, jojoba oil, grape seed oil, rape seed oil, cod liver oil, salmon oil, tuna oil, citrus oil, castor oil, mineral oil and mixtures thereof.

30. The pencil and crayon sharpener of claim 28 wherein the liquid further comprises a viscosity modifier.

31. The pencil and crayon sharpener of claim 30 wherein the viscosity modifier is selected from the group consisting of alkyn-diols, polyalkyneoxides, alkylphenolethoxylates, alkylphenylsulfates, alkylesters, one or more lecithins and mixtures thereof.

32. The pencil and crayon sharpener of claim 28 wherein the at least one dye is soluble in the polar system is selected from the group consisting of FD&C Blue 1, FD&C Green 3, FD&C Yellow 5, FD&C Yellow 6, FD&C Black 2, FD&C Red 40, and mixtures thereof.

33. The pencil and crayon sharpener of claim 29 wherein the at least one dye is soluble in the non-polar system is selected from the group consisting of Solvent Red 164, Solvent Blue 70, Oil Black 2, Solvent Blue 90, solvent yellow and mixtures thereof.

34. The pencil and crayon sharpener of claim 28 further comprising ingestible glitter particles.

35. A calculator comprising:
a housing comprising an isolated reservoir for accommodating a non-toxic novelty fluid composition, the composition comprising
a polar system comprising at least one polar solvent selected from the group consisting of glycerol, one or more glycols an aqueous NaCl solution, an aqueous KCl solution, an aqueous MgCl₂ solution, an aqueous MgSO₄ solution and mixtures thereof,
a non-polar system comprising at least one edible oil, and
at least one dye soluble in either the polar or the non-polar system.

36. The calculator of claim 35 wherein the edible oil of the liquid is selected from the group consisting of coconut oil, palm oil, peanut oil, sesame seed oil, rice bran oil, soybean oil, cottonseed oil, olive oil, canola oil, corn oil, sunflower seed oil, safflower oil, infused oil, almond oil, apricot kernel oil, jojoba oil, grape seed oil, rape seed oil, cod liver oil, salmon oil, tuna oil, citrus oil, castor oil, mineral oil and mixtures thereof.

37. The calculator of claim 35 wherein the liquid further comprises a viscosity modifier.

38. The calculator of claim 35 wherein the viscosity modifier is selected from the group consisting of alkyn-diols, polyalkyneoxides, alkylphenolethoxylates, alkylphenylsulfates, alkylesters, one or more lecithins and mixtures thereof.

39. The calculator of claim 35 wherein the at least one dye is soluble in the polar system is selected from the group consisting of FD&C Blue 1, FD&C Green 3, FD&C Yellow 5, FD&C Yellow 6, FD&C Black 2, FD&C Red 40, and mixtures thereof.

40. The calculator of claim 35 wherein the at least one dye is soluble in the non-polar system is selected from the group consisting of Solvent Red 164, Solvent Blue 70, Oil Black 2, Solvent Blue 90, solvent yellow and mixtures thereof.

41. The calculator of claim 35 further comprising ingestible glitter particles.
